(19) United States
(12) Patent Application Publication
(10) Pub. No.: US 2012/0299720 A1
(43) Pub. Date: Nov. 29, 2012

(54) Disabled auto alert - (Portable Emergency Flasher)

(76) Inventor: Karl Colon Griner, Callahan, FL (US)

(21) Appl. No.: 13/098,708

(22) Filed: May 23, 2011

(51) Int. Cl. B60Q 7/00

(52) U.S. Cl. 340/473

(57) ABSTRACT

1. A new, self contained, Disabled Auto Alert device(portable emergency flasher device), primarily but not limited to, the identification at a reasonable distance of a disabled or elderly persons as being in a state of distress or in need of assistance along a public roadway or other places. The selection and utilization of a distinctive color of the flashing light source (purple/magenta) is critical to the functional utility of the device. This purpose of the unique color is to prevent confusion with other common emergency lighting devices. Examples include the blue lights of police vehicles, red and amber (yellow) lights common to official emergency vehicles such as fire trucks and ambulances or the colors of traffic control lights and road hazard signaling. The intent of the flasher is to radiate the light of suitable color and brightness in all directions of approximately a half hemisphere or along a more or less horizontal plane.

2. The light production occurs by using a plurality of methods. For example, a single light source of the appropriate color, with suitable optics generating the desired illumination pattern, or by the use of multiple light sources with or without optics to achieve the same result. The light source may be a combination of colored light emitting devices mixed in certain ratios that yield the desired color.

1. A plastic housing of a general rectangular profile with a raised optical dome attached to one side of the major housing surface. The general construction of the enclosure able to withstand exposure to rain for several hours.

2. A control switch on the enclosure to turn the device ON /OFF or, as an option, additional switch positions or controls to regulate the light output such as selecting between flashing and constant ON.

3. The power source comes from a battery compartment within the enclosure. The compartment has a weather resistant access cover so that the user may replace the batteries as needed. Or, as an option, the batteries can be rechargeable with provisions on the enclosure for a weather resistant power jack to accept power from an external power source or charger.

4. An electrical or electronic circuit within the enclosure that provides the proper drive control for the light source(s).

5. This invention produces the unique light color by combining the controlled output of multiple high brightness light sources of various colors, or by providing power to a single narrow-spectrum light source or by filtration of a white or other broad spectrum light source. These light sources are in close enough proximity, when viewed through the proper diffusers and optics, to produce the specific color at sufficient intensity. This assembly is commonly referred to as a ‘light engine’.

6. The bottom side of the enclosure has a magnetic sheet bonded to its surface so that the invention will cling to a steel surface such as the roof or door of an automobile.

7. The enclosure also can have loop holes to accept a string or strap to secure the device to other surfaces in various orientations.

8. The enclosure also can have attached suction cups to secure the device to other surfaces in various orientations.

9. It is the design intent of this invention to provide a flashing or continuously ON light of sufficiently unique spectral color to be easily recognized at a distance as distinct and, by statute or government regulation, reserved to indicate disabled or elderly persons in need of assistance.

10. The invention consists of a single enclosure requiring no external connections for its operation.

Within the enclosure is contained but not limited to the following elements; a portable replaceable means to power the device such as a battery, a connector for external connection to a source of electrical power, an electrical/electronic control circuit. Further, the enclosure contains a light source consisting of a single or plurality of light emitters capable of producing the unique light color, and any necessary optical enhancements to achieve the desired illumination pattern. Additional features of the device include the means to permit attachment to various surfaces by magnetic or a plurality of mechanical methods, a switch or switches to turn the device ON/ OFF and, as an option, regulate the light output.

### BRIEF DESCRIPTION

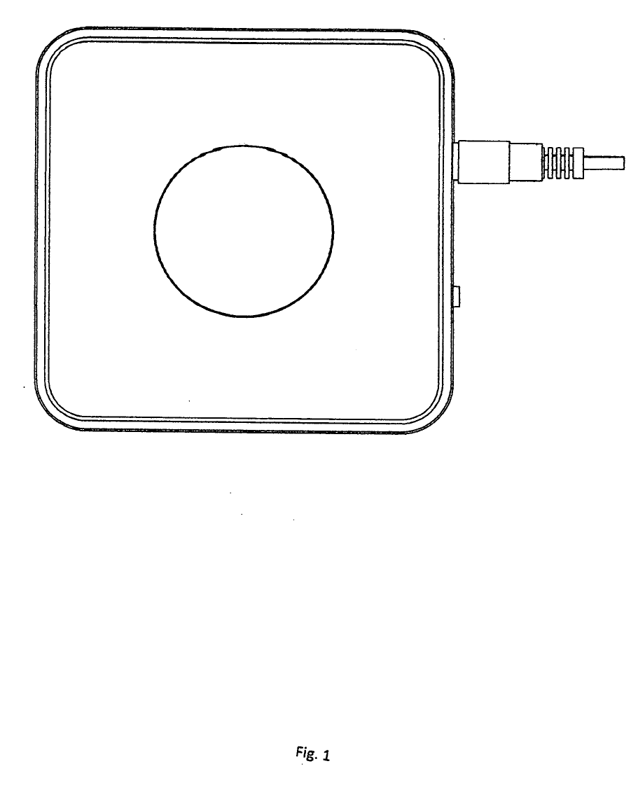

FIG. 1, depicts the disabled auto alert from the top. The power switch and power outlet is shown on the left side of the unit with the dome beacon on top.

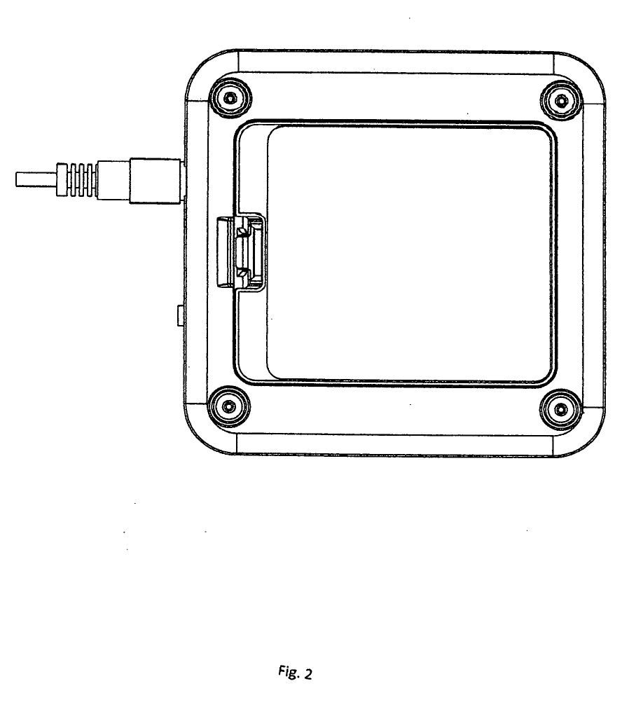

FIG. 2, depicts the back of the unit where the magnetic strip is attached to the battery Compartment door.

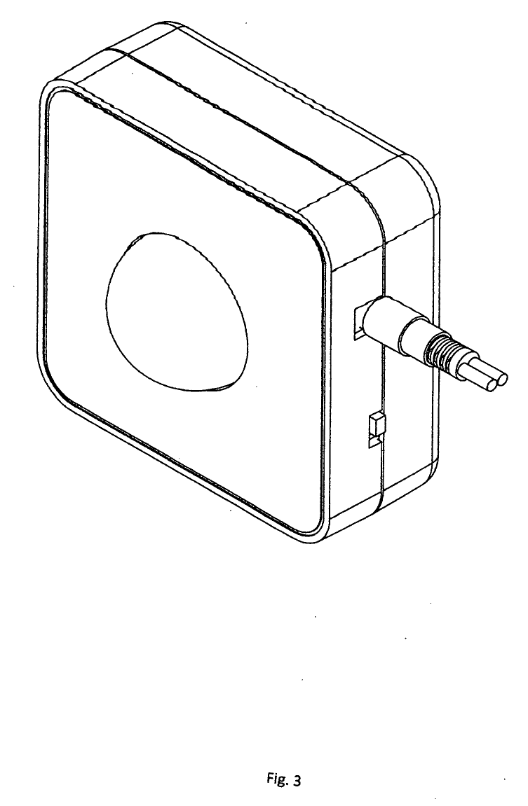

FIG. 3, depicts the battery door removed and shows the battery compartment.

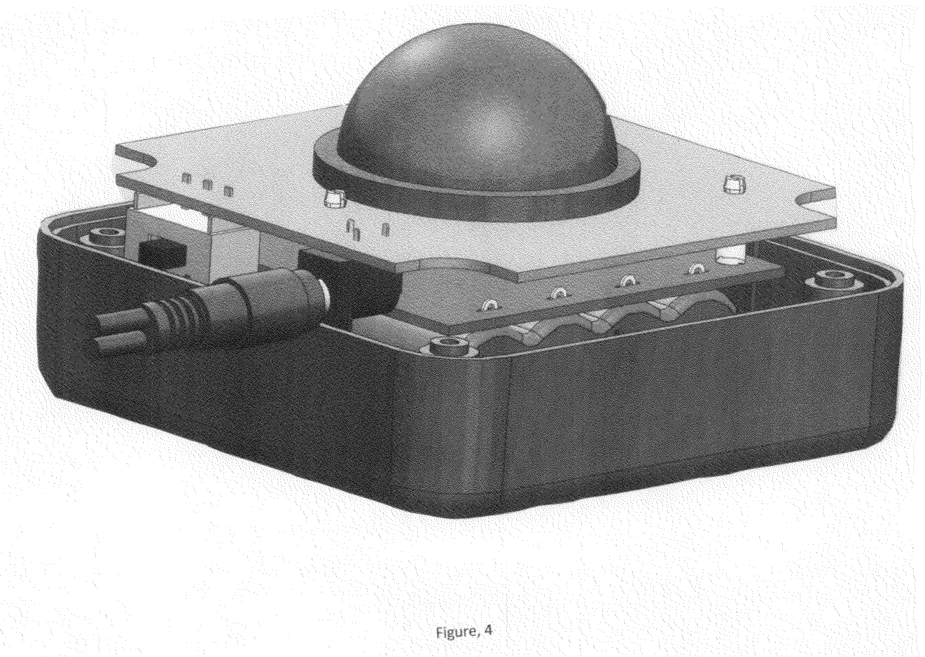

FIG. 4, depicts the interior of the unit with the top of the unit cover removed, and the dome still attached to the electronics board.

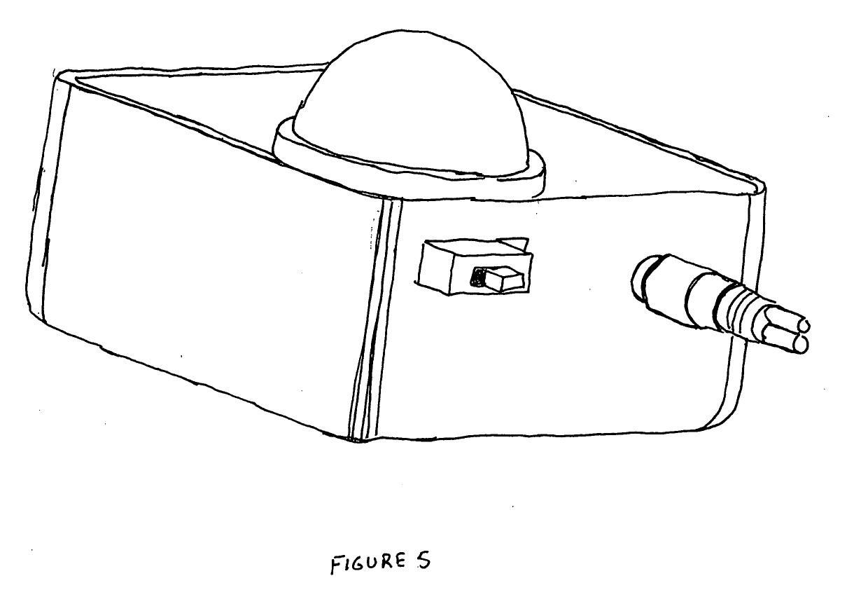

FIG. 5, is a transparent view of the unit that shows how the components are arranged inside the unit.

1. The Disabled auto Alert is a portable emergency flasher which will, when activated, notify other motorists and emergency personnel that the person displaying and or using the devise is in need of emergency assistance. The unique color, purple/magenta, will serve as a universal symbol and be recognized as a need for assistance. The unit will be deployed by elderly, disabled or any motorists who has become stranded on the roadside and have no other means of communication such as a cell phone, cell signal or in car call service.

2. The disabled Auto Alert when used, will aid individuals who find themselves stranded, one more layer of protection from being stranded for long periods of time. This in some cases could be life threatening if assistance is not rendered in a timely manner.
